(19) United States
(12) Patent Application Publication
(10) Pub. No.: US 2019/0331059 A1
(43) Pub. Date: Oct. 31, 2019

(54) Composite-Overwrapped Multi-Metallic Thrust Chamber Liner

(71) Applicant: United States of America as represented by the Administrator of NASA, Washington, DC (US)

(72) Inventors: Paul R. Gradl, Owens Cross Roads, AL (US); William C. C. Brandsmeier, Owens Cross Roads, AL (US); Cory R. Medina, Meridianville, AL (US); Christopher Stephen Protz, Huntsville, AL (US); Justin R. Jackson, Huntsville, AL (US)

(21) Appl. No.: 15/965,239

(22) Filed: Apr. 27, 2018

(51) Int. Cl. F02K 1/82; B32B 1/08; B32B 3/14; B32B 15/04

(52) U.S. Cl. CPC F02K 1/822; B32B 1/08; B32B 2597/00; B32B 15/04; F05D 2260/20; B32B 3/14

(57) ABSTRACT

A thrust chamber liner for a rocket engine includes a main combustion chamber (MCC) and a nozzle. A composite wrap covers the outside surface of the MCC and the outside surface of the nozzle.

### ORIGIN OF THE INVENTION

The invention described herein was made by employees of the United States Government and may be manufactured and used by or for the Government of the United States of America for governmental purposes without the payment of any royalties thereon or therefore.

### CROSS-REFERENCE TO RELATED PATENT APPLICATIONS

This patent application is co-pending with two related patent applications entitled “SEAL-FREE MULTI-METALLIC THRUST CHAMBER LINER” and “METHOD FOR FABRICATING SEAL-FREE MULTI-METALLIC THRUST CHAMBER LINER”, owned by the same assignee as this patent application.

### BACKGROUND OF THE INVENTION

### 1. Field of the Invention

This invention relates to rocket engine thrust chamber assemblies. More specifically, the invention is a thrust chamber liner having its main combustion chamber and nozzle wrapped by a composite material.

### 2. Description of the Related Art

The basic operation of a liquid rocket engine provides thrust through injection of a fuel and oxidizer into a combustion chamber for the formation of hot gases that expand through a nozzle. The assembly supporting this process is what is known as a thrust chamber assembly (TCA). In general, a TCA includes an injector, a main combustion chamber (MCC), and a nozzle portion. In order to properly maintain adequate temperatures for the materials that make up the wall of the thrust chamber, the walls are regeneratively-cooled using the fuel or oxidizer as a coolant prior to its being injected into the TCA combustion chamber for the combustion process. As the heat flux further down the nozzle decreases, a radiantly-cooled nozzle extension can be used to reduce weight of the TCA.

A typical TCA includes an injector that is bolted or welded to a combustion chamber that, in turn, is bolted or welded to the regeneratively-cooled portion of the nozzle. At each join location or joint, very tight tolerances are required with polished surface finishes and complex seals in order to prevent leakage. These joints also require tight-tolerance concentricity of each component and ancillary features such as shear-lips to prevent hot gas circulation in the join and/or joint separation. Each such joint presents a possible leakage location that can cause burn-through of adjacent components and catastrophic failure of the engine or vehicle.

The complex TCA joints also require several design iterations to determine the optimal axial locations based on allowable cooling for the materials used, and to ensure a design option that properly cools all of the material at all locations along the TCA wall. Some of the most problematic design issues occur in the downstream end of the main combustion chamber and the upstream end of the nozzle where the coolant enters. There is a finite amount of material required in these locations where the coolant channels start and the material/design must contain the pressure within. Any uncooled portions will see very high temperatures potentially leading to material erosion if not designed properly. The design complexity is inherent due to the use of separate manifolds for each component. The joints, even when properly sealed, add significant weight since they must have a series of bolt-hole patterns (outboard of the actual combustion chamber/nozzle hotwall) to put the joint in proper compression for sealing. The joints also require high tolerances to properly fit and prevent any forward facing steps into the hot gas flow.

Typical TCAs utilize a variety of separately-fabricated components due to manufacturing complexities and the use of different materials for the different components leading to increased cost, complexity, and fabrication time. Another disadvantage of separately-fabricated components is the inability to fully optimize the inlet and outlet manifold flow circuits. The inlet manifolds for the combustion chamber and nozzle are located at the same point to optimize the colder fluid flows for the higher heat flux regions. Since the components are fabricated separately, separate manifolds are fabricated for the main combustion chamber outlet and nozzle inlet leading to the above-described sealing and weight issues.

### SUMMARY OF THE INVENTION

Accordingly, it is an object of the present invention to provide a reduced-weight multi-metallic thrust chamber liner.

Other objects and advantages of the present invention will become more obvious hereinafter in the specification and drawings.

In accordance with the present invention, a thrust chamber liner for a rocket engine includes a main combustion chamber (MCC) having an outside surface. A nozzle is coupled to the MCC. The nozzle has an outside surface. A composite wrap covers the outside surface of the MCC and the outside surface of the nozzle.

### BRIEF DESCRIPTION OF THE DRAWING(S)

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a cross-sectional view of an integrated liner and manifolds of a thrust chamber assembly to include a main combustion chamber, a nozzle, and coolant-channel manifolds in accordance with an embodiment of the present invention;

FIG. 2 is a cross-sectional schematic view of a portion of the main combustion chamber and nozzle illustrating a single coolant-supply manifold at the interface of the main combustion chamber and nozzle in accordance with an embodiment of the present invention;

FIG. 3 is a cross-sectional schematic view of a portion of the main combustion chamber and nozzle illustrating a single coolant-supply manifold at the throat of the main combustion chamber in accordance with another embodiment of the present invention;

FIG. 4 is a flow diagram of a method used to fabricate the integrated main combustion chamber and nozzle in accordance with an embodiment of the present invention;

FIG. 5 is a schematic view of a Selective Laser Melting (SLM) set-up to fabricate a nozzle transition ring in accordance with an embodiment of the present invention;

FIG. 6 is a schematic view of the SLM set-up at the beginning of the fabrication of a main combustion chamber (MCC) that results in an integrated nozzle transition ring and MCC interface in accordance with an embodiment of the present invention;

FIG. 7 is an enlarged schematic view illustrating a melted copper-alloy and melted portion of the nozzle transition ring;

FIG. 8 is an enlarged schematic view illustrating the integrated region of the melted copper-alloy and melted nozzle transition ring; and

FIG. 9 is a cross-sectional view of an integrated liner and manifolds of a thrust chamber assembly to further include a composite overwrap in accordance with another embodiment of the present invention.

### DESCRIPTION OF THE PREFERRED EMBODIMENT(S)

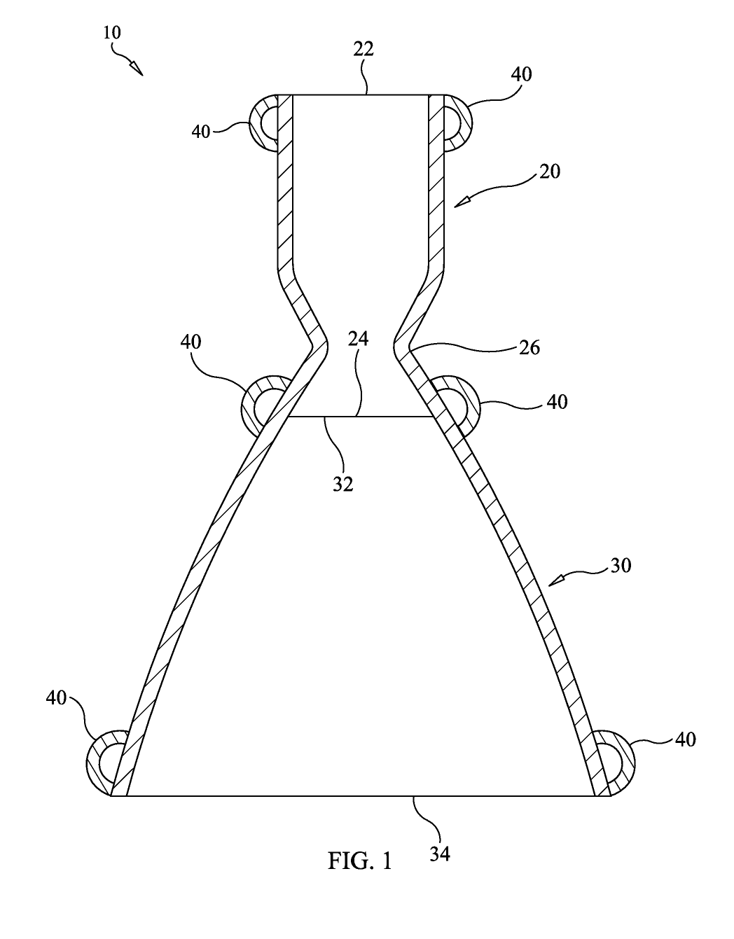

Referring now to the drawings and more particularly to FIG. 1, a cross-sectional view of the liner to include coolant manifolds of a thrust chamber assembly (TCA) in accordance with an embodiment of the present invention is shown and will be referred to hereinafter as TCA 10. As is known in the art, a TCA liner forms a portion of a rocket engine that includes a number of parts/systems coupled thereto that have been omitted from the figures for clarity of illustration. Such parts/systems are well-known in the art and do not comprise or limit the novel features of the present invention.

TCA 10 includes a main combustion chamber (MCC) 20, a nozzle 30, and a number of coolant-channel manifolds 40 that facilitate movement of coolant fluid (e.g., fuel or oxidizer) along axial coolant channels (not shown in FIG. 1 for clarity of illustration) incorporated in MCC 20 and nozzle 30. It is to be understood that the illustrated shapes of MCC 20, nozzle 30, and manifolds 40 are exemplary and that other shapes can be used without departing from the scope of the present invention.

In general, MCC 20 has an inlet 22, a downstream outlet 24, and a throat 26 disposed between inlet 22 and outlet 24. Due to the extreme heat generated in MCC 20, a high-thermally conductive material (e.g., copper-alloys GRCop-84, C18150, C18200, AMZIRC, GLIDCOP) is used for MCC 20. As mentioned above and as will be explained further below, axially-aligned coolant channels (not shown in FIG. 1) are integrated into the walls of MCC 20.

Nozzle 30 has an inlet 32 and an outlet 34. As will be explained further below, the present invention includes a novel fabrication process that provides for the integration of inlet 32 of nozzle 30 to outlet 24 of MCC 20. This is a significant achievement in the art given that nozzle 30 is generally made from a lower thermal conductivity material such as a stainless steel (e.g., A-286, 321, 347) or a superalloy (e.g., INCONEL 625, HAYNES 230). As mentioned above and as will be explained further below, axially-aligned and closed coolant channels (if included in the TCA design) are integrated into some or all of the length of the walls of nozzle 30 between inlet 32 and outlet 34.

Manifolds 40 are integrated with the outside of MCC 20 and nozzle 30. In general, manifolds 40 encircle TCA 10 and fluidly couple coolant channels in MCC 20 and/or nozzle 30 to thereby define coolant circuits. Manifolds can be made from a stainless steel (e.g., A-286, 321, 347), a superalloy (e.g., INCONEL 625, HAYNES 230), or a multi-metallic combination of these. Manifolds 40 are integrated with MCC 20 and/or nozzle 30 using a bimetallic deposition process as will be explained further below. Manifold 40 at inlet 22 and outlet 34 introduces or supplies coolant fluid into MCC 20 and nozzle 30, while the remaining manifolds 40 facilitate extraction of the coolant fluid for use in MCC 20 when the coolant fluid is a fuel or oxidizer.

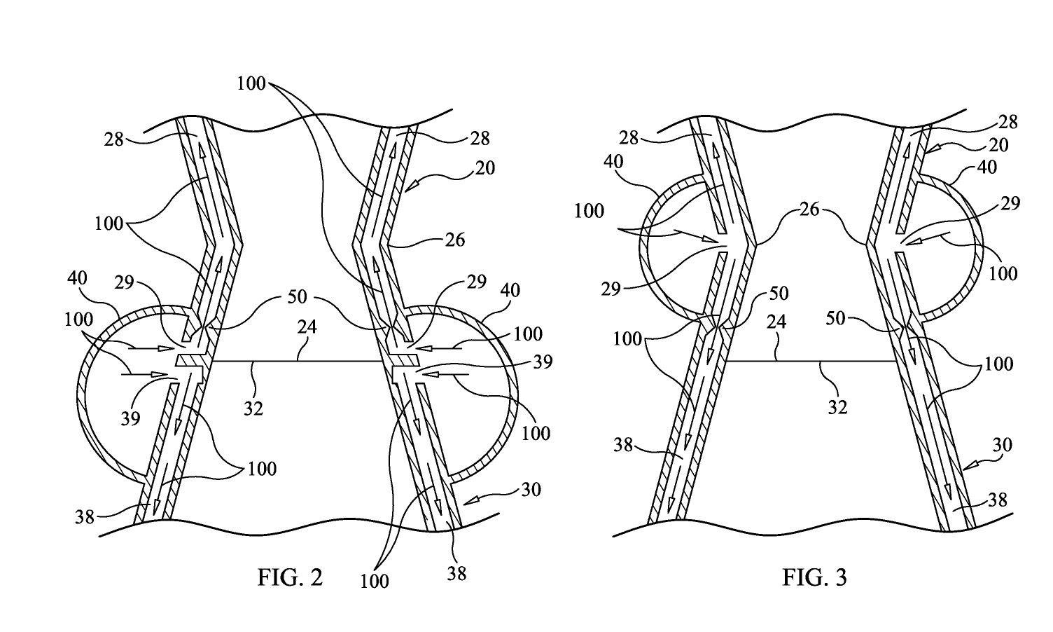

Referring now to FIGS. 2 and 3, schematic cross-sectional views are presented of a portion of MCC 20 interfacing with a portion of nozzle 30. In each illustrated embodiment, a single coolant-supply manifold 40 is used to facilitate the introduction of coolant into the coolant channels of the MCC and the coolant channels of the nozzle. In each embodiment, each of closed coolant channels 28 of MCC 20 are in fluidic communication with one or more coolant channels 38 of nozzle 30. For example, in FIG. 2, each coolant channel 28 is ported at 29 to the outside surface of MCC 20 at outlet 24, and each coolant channel 38 is ported at 39 to the outside surface of nozzle 30 at inlet 32. The single coolant-supply manifold 40 links all ports 29 and 39 to the supply of coolant.

Manifold 40 is integrally coupled to the outside of surfaces of MCC 20 and nozzle 30 such that ports 29 and 39 are in fluid communication with the coolant-supply manifold 40 as shown. In this way, coolant fluid injected into the coolant-supply manifold 40 (which encircles TCA 10) is made available to each MCC coolant channel 28 and each nozzle coolant channel 38 as indicated by arrows 100. To control coolant fluid amounts and rates in channels 28 and 38, flow restrictors (e.g., integral flow orifices, venturis, cavitating venturis, etc.) can be incorporated into each coolant channel 28 and/or each coolant channel 38. For example FIG. 2 illustrates a flow restrictor 50 in each coolant channel 28.

Referring now to the FIG. 3, another single coolant-supply manifold design is illustrated. In this embodiment, each port 29 is provided at throat 26 of MCC 20, and each coolant channel 28 is contiguous with a corresponding coolant channel 38. Such coolant channel coupling is made possible by the novel fabrication process to be described later below. The coolant-supply manifold 40 is integrally coupled to the outside surface of MCC 20 and encircles throat 26. In this way, coolant fluid 100 injected into the coolant-supply manifold 40 is made available to each coolant channel 28 where it can travel to each corresponding coolant channel 38. As in the previous embodiment, a flow restrictor 50 can be placed in each coolant channel 28 (and/or in coolant channel 38) to control flow amounts/rates.

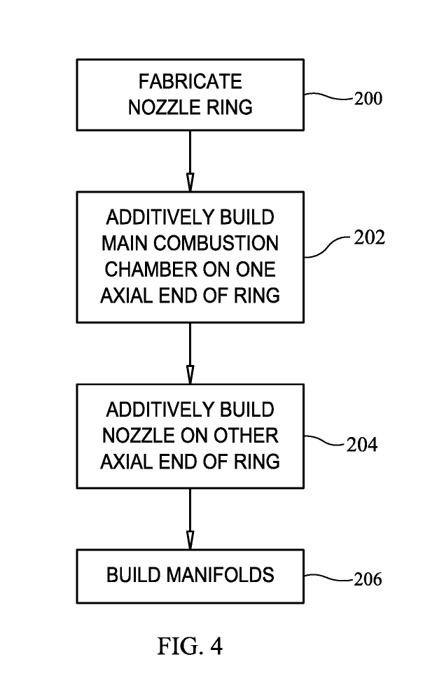

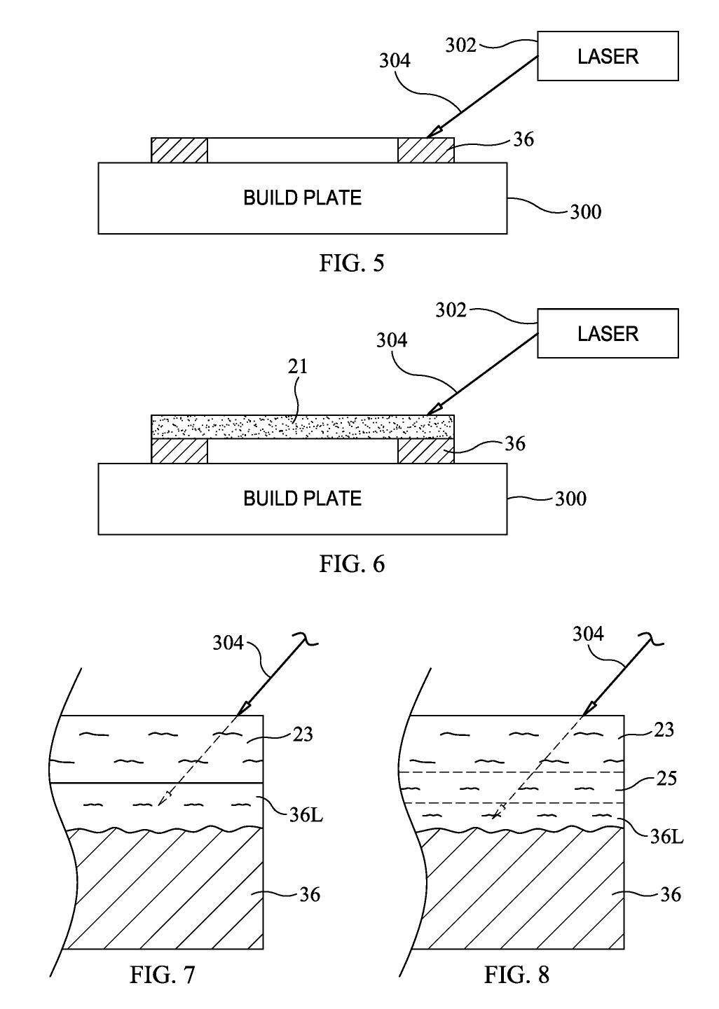

The above-described TCA embodiments are made possible by a novel process for the fabrication of MCC 20 and nozzle 30 as an integrated TCA liner requiring no seals or bolting at the interface of MCC 20 and nozzle 30, i.e., where outlet 24 interfaces with inlet 32. In describing this novel fabrication process, reference will be made to FIGS. 1-3, as well as to the process flow diagram presented in FIG. 4 and schematic drawings in FIGS. 5-8. As an initial step 200, a nozzle transition ring 36 (FIGS. 5-8) is fabricated from the stainless steel or superalloy that will be used for nozzle 30. Nozzle transition ring 36 will ultimately define inlet 32 of nozzle 30. The transition ring can include closed coolant channels extending axially there along to define the beginnings of the above-described nozzle coolant channels 38. The transition ring can also include the above-described ports 39 depending on the ultimate TCA design. For clarity of illustration, neither channels 38 nor ports 39 are illustrated in FIGS. 5-8.

Nozzle transition ring 36 is a thin (i.e., short in the axial dimension with a typical axial length or thickness being on the order of 0.015-0.025 inches) ring-shaped structure fabricated, deposited, or otherwise positioned upon a build plate 300 that is commonly used in additive manufacturing process such as Powder-bed Fusion (PBF) or Selective Laser Melting (SLM). One end face of the ring-shaped structure (i.e., one axial end) is used for the deposition/build of MCC 20, while the opposing end face (i.e., the other axial end) is used for the deposition/build of nozzle 30. As shown in FIG. 5, one axial end of transition ring 36 rests on build plate 300, while the opposing axial end of transition ring 36 is exposed. Nozzle transition ring 36 can be fabricated using PBF, SLM, or an alternate energy deposition or solid-state process such as Directed Energy Deposition (DED), coldspray, ultrasonic, or arc-wire cladding. Nozzle transition ring 36 may or may not include coolant channels depending on the design configuration of the TCA. For purposes of the ensuing description, it will be assumed that fabrication will proceed using an SLM system/process that includes a laser 302 capable of being controlled to produce a laser beam 304 of desired power.

The fabricated transition ring 36 is then used at step 202 in an additive manufacturing process to integrate MCC 20 with the ring. Briefly, step 202 employs a SLM (or PBF) layer-by-layer additive manufacturing process that builds a copper-alloy MCC 20 with the above-described integral coolant channels 28 and ports 29 onto the exposed axial end of the transition ring from step 200. In general, the build process of the present invention causes the copper-alloy MCC 20 to integrate with the transition ring. For example, the SLM process uses laser melting to integrate the copper-alloy with nozzle transition ring 36. Prior to the copper-alloy processing, transition ring 36 can have residual powder or contaminants removed from its surface. Further, although not required, the surface of transition ring 36 could be precision cleaned or etched to remove any oxides that might prevent or contaminate subsequent processing.

Referring to FIG. 6, a base layer comprising copper-alloy powder 21 is deposited on the exposed axial end of the fabricated and solid nozzle transition ring 36. Typical thickness of powder 21 is in the range of approximately 0.002-0.012 inches. Laser 302 is then directed towards powder 21 and ring 36, and is operated/controlled such that the energy associated with laser beam 304 penetrates through copper-alloy powder 21 and partially into transition ring 36 as indicated by the dashed-line extension of laser beam 304 shown in FIG. 7. The power of laser beam 304 is selected such that copper-alloy powder 21 (FIG. 6) melts to form melted copper-alloy 23 (FIG. 7), and such that a portion 36L of transition ring 36 (adjacent to and just below melted copper-alloy 23) also melts to a liquid state. Once this occurs, adjoining portions of melted copper-alloy 23 and melted transition ring 36L intermix to form an integrated region 25 as shown in FIG. 8. The resulting intermetallic mixing allows for diffusion of the MCC's copper-alloy material into the transition ring's material. Laser beam 304 is then removed or turned off to allow the resulting liquefied regions 23, 25 and 36L to solidify to create a permanent and seal-free bond of the two materials.

Once solidified, integrated region 25 defines a functional gradient transition between what will become MCC 20 and nozzle 30 thereby preventing a step change between the materials used for MCC 20 and nozzle 30. That is, in transitioning from MCC 20 to nozzle 30, integrated region transitions from 100% of the MCC's material through a changing gradient of a mixture of the MCC's material and the nozzle's material before finally transitioning to 100% of the nozzle's material. The gradient function defined in integrated region 25 can be controlled using various process parameters.

The SLM process and design model used for fabrication can also be used to create relief features (e.g., surface roughness, fingers, etc.) on the outside surface of MCC 20. Such relief features improve adherence of a composite material overwrap as will be explained further below. Ports (not shown) at the outside surface of inlet 22 of MCC 20 are also included for fluidic communication with a manifold 40 encircling TCA 10 at inlet 22 such that coolant fluid can be extracted from the MCC's coolant channels after passing there through. Following fabrication of the copper-alloy MCC to the nozzle transition ring, the entire assembly is removed from the build plate using processes commonly known in the art.

Next, at step 204, transition ring 36 and the built-up MCC coupled thereto are removed from build plate 300 so that the other axial end face of transition ring 36 fabricated in step 200 can be used as the base for an additive build of nozzle 30 to include its integrated coolant channels 38 and, if needed, ports 39. Ports (not shown) at the outside surface of outlet 34 of nozzle 30 are also included for fluid communication with manifold 40 encircling TCA 10 at outlet 34. In general, the build process of the present invention causes the material used for nozzle 30 to integrate with the above-described transition ring 36. Since the materials used for nozzle 30 and transition ring 36 are the same, integration of the added layers forming nozzle 30 can follow standard build procedures. The fabrication process options for nozzle 30 include a freeform deposition technique (e.g., blown powder deposition, directed energy deposition, laser metal deposition, wire-fed laser deposition, electron beam deposition) or a solid-state additive deposition technique (e.g., coldspray, ultrasonic, friction stir) in which multi-axis or layer-by-layer additive manufacturing is applied. The coolant channels are formed integrally with the nozzle as it is being fabricated.

Finally, at step 206, the above-described TCA liner has manifolds 40 integrally coupled to the outside surface of the TCA liner using a freeform deposition process or a secondary welding operation to bond a subassembly of the manifolds. The design for the above-described builds of MCC 20 and nozzle 30 can include additional manifold land stock material for welding the manifolds. The welding of the manifolds to the manifold lands for the MCC can include an integral bimetallic, multi-metallic, or gradient material layer to transition from the copper-alloy to the stainless or superalloy. The processes for fabricating manifold lands can include any from a group of deposition techniques including directed energy deposition (i.e., blown powder deposition, arc-wire cladding) or solid-state deposition (i.e., coldspray, ultrasonic, plating). Conversely, the manifolds may be welded or bonded directly to the support structure fabricated during the manufacturing of the nozzle and MCC through means of laser welding or electron beam welding allowing for intermetallic mixing in the weld zone.

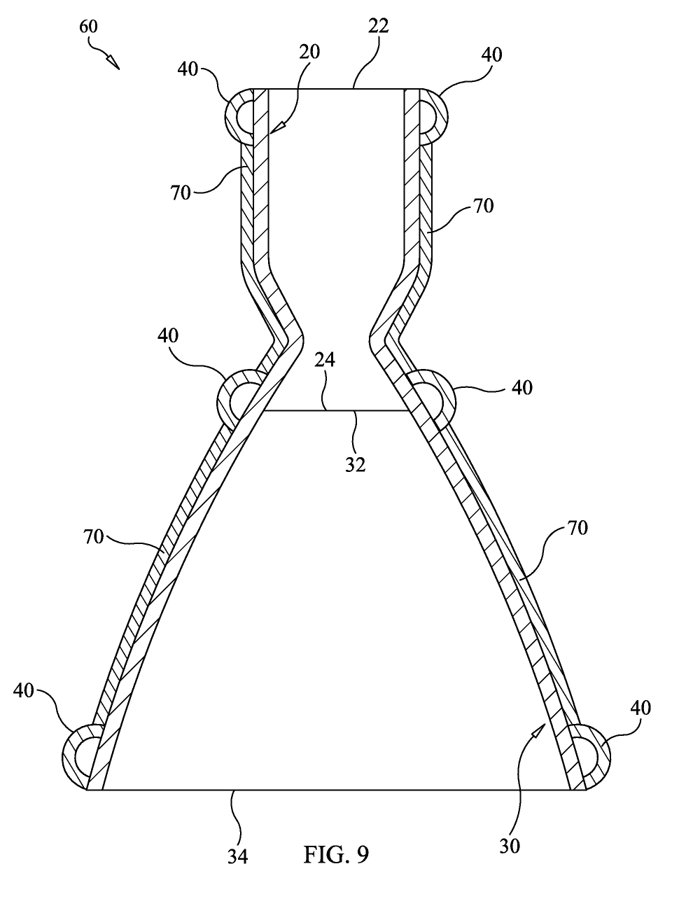

The TCA and fabrication thereof in accordance with the present invention can be further modified for reduced weight and increased strength in the face of radial pressure loads and axial thrust loads. Referring now to FIG. 9, a TCA 60 includes the features described above. Once again, the coolant channels shown in FIGS. 2-3 have been omitted from FIG. 9 for clarity of illustration. TCA 60 includes a composite overwrap 70 on exposed portions of MCC 20 and nozzle 30, i.e., overwrap 70 can be applied using any of a variety of known composite fabrication techniques without departing from the scope of the present invention. The techniques for applying the composite may include hand layup, filament winding, and tape wrap winding using wet and dry layup techniques. Materials used for composite overwrap 70 can include, for example, carbon fiber composites, fiber-reinforced polymer composites, metal matrix composites, and ceramic matrix composites. The composite binder material is selected based on the backside (i.e., the coldwall) temperatures and should be sufficient to withstand elevated temperatures (generally no greater than 500° F.), but also withstand cryogenic temperatures during startup of the engine and TCA.

The fabrication process to include a composite overwrap as described herein creates a seal-free TCA liner using reduced amounts of copper and stainless or superalloy to close out the coolant channels of MCC 20 and nozzle 30, respectively. The lighter and stronger composite overwrap 70 provides the needed strength at a reduced weight. The composite overwrap fabrication strategy uses varying fiber placement to provide strength to react axial thrust loads, radial pressure loads, thermal shocks and strains, and gimbaling loads. The composite overwrap fabrication can use relief features on the liner's outer surface such that the composite overwrap's weave patterns can react to the structural loads.

The use of a composite overwrap can also be employed in other TCA designs to reduce the amount of coolant channel close out material. For example, the amount of coolant channel closeout material used in the method disclosed in the U.S. Pat. No. 9,835,114 could be reduced when the above-described composite overwrap is employed.

The advantages of the present invention are numerous. The TCA liner requires no seals or bolts at the MCC-to-nozzle interface thereby eliminating leak points and excess weight. The TCA liner fabrication process simplifies and improves coolant fluid distribution along the TCA. The TCA liner fabrication process facilitates the use of minimal coolant-channel closeout material with the composite overwrap feature providing the necessary strength at a reduced weight.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A thrust chamber liner for a rocket engine, comprising:
a main combustion chamber (MCC) having an outside surface;
a nozzle coupled to said MCC, said nozzle having an outside surface; and
a composite wrap covering said outside surface of said MCC and said outside surface of said nozzle.

2. A thrust chamber liner as in claim 1, wherein said composite wrap includes a composite material selected from the group consisting of carbon fiber composites, fiber-reinforced polymer composites, metal matrix composites, and ceramic matrix composites.

3. A thrust chamber liner as in claim 1, wherein said MCC comprises a copper-alloy.

4. A thrust chamber liner as in claim 1, wherein said nozzle comprises a material selected from the group consisting of stainless steel and a superalloy.

5. A thrust chamber liner for a rocket engine as in claim 1,
wherein said MCC has closed MCC coolant channels extending axially there along, each of said MCC coolant channels having a port at said outside surface of said MCC,
wherein said nozzle has closed nozzle coolant channels extending axially there along, and
wherein said thrust chamber liner further comprises a coolant-supply manifold coupled to one of said outside surface of said MCC, and
said outside surface of said MCC and said outside surface of said nozzle,
wherein said coolant-supply manifold is in fluid communication with each said port in said MCC coolant channels.

6. A thrust chamber liner as in claim 5, wherein each of said MCC coolant channels is in direct fluid communication with a corresponding one of said nozzle coolant channels.

7. A thrust chamber liner as in claim 5, wherein each of said nozzle coolant channels has a port at said outside surface of said nozzle, wherein said coolant-supply manifold is coupled to said outside surface of said MCC and said outside surface of said nozzle, and wherein said coolant-supply manifold is in fluid communication with each said port in said MCC coolant channels and each said port in said nozzle coolant channels.

8. A thrust chamber liner as in claim 5, further comprising a flow restrictor disposed in at least one of each of said MCC coolant channels and each of said nozzle coolant channels.

9. A thrust chamber liner for a rocket engine, comprising:
a main combustion chamber (MCC) made from a copper-alloy, said MCC having an outside surface;
a nozzle integrated with said MCC, said nozzle being made from a material selected from the group consisting of stainless steel and a superalloy, said nozzle having an outside surface; and
a composite wrap covering said outside surface of said MCC and said outside surface of said nozzle.

10. A thrust chamber liner as in claim 9, wherein said composite wrap includes a composite material selected from the group consisting of carbon fiber composites, fiber-reinforced polymer composites, metal matrix composites, and ceramic matrix composites.

11. A thrust chamber liner for a rocket engine as in claim 9,
wherein said MCC has closed MCC coolant channels extending axially there along, each of said MCC coolant channels having a port at said outside surface of said MCC,
wherein said nozzle has closed nozzle coolant channels extending axially there along, and
wherein said thrust chamber liner further comprises a coolant-supply manifold coupled to one of said outside surface of said MCC, and
said outside surface of said MCC and said outside surface of said nozzle,
wherein said coolant-supply manifold is in fluid communication with each said port in said MCC coolant channels.

12. A thrust chamber liner as in claim 11, further comprising a flow restrictor disposed in at least one of each of said MCC coolant channels and each of said nozzle coolant channels.

13. A thrust chamber liner as in claim 11, wherein each of said MCC coolant channels is in direct fluid communication with a corresponding one of said nozzle coolant channels.

14. A thrust chamber liner as in claim 11, wherein each of said nozzle coolant channels has a port at said outside surface of said nozzle, wherein said coolant-supply manifold is integrated with said MCC and said nozzle, and wherein said coolant-supply manifold is in fluid communication with each said port in said MCC coolant channels and each said port in said nozzle coolant channels.

15. A thrust chamber liner for a rocket engine, comprising:
a main combustion chamber (MCC) having an outside surface and having closed MCC coolant channels extending axially there along, each of said MCC coolant channels having a port at said outside surface of said MCC;
a nozzle extending axially from said MCC, said nozzle having an outside surface and having closed nozzle coolant channels extending axially there along;
a single coolant-supply manifold coupled to one of said outside surface of said MCC, and
said outside surface of said MCC and said outside surface of said nozzle,
said single coolant-supply manifold in fluid communication with each said port in said MCC coolant channels;
a flow restrictor disposed in at least one of each of said MCC coolant channels and each of said nozzle coolant channels; and
a composite wrap covering at least exposed portions of said outside surface of said MCC and exposed portions of said outside surface of said nozzle.

16. A thrust chamber liner as in claim 15, wherein each of said MCC coolant channels is in direct fluid communication with a corresponding one of said nozzle coolant channels.

17. A thrust chamber liner as in claim 15, wherein each of said nozzle coolant channels has a port at said outside surface of said nozzle, wherein said single coolant-supply manifold is coupled to said MCC and said nozzle, and wherein said single coolant-supply manifold is in fluid communication with each said port in said MCC coolant channels and each said port in said nozzle coolant channels.

18. A thrust chamber liner as in claim 15, wherein said composite wrap includes a composite material selected from the group consisting of carbon fiber composites, fiber-reinforced polymer composites, metal matrix composites, and ceramic matrix composites.

19. A thrust chamber liner as in claim 15, wherein said MCC comprises a copper-alloy.

20. A thrust chamber liner as in claim 15, wherein said nozzle comprises a material selected from the group consisting of stainless steel and a superalloy.
